(19) United States
(12) Patent Application Publication
(10) Pub. No.: US 2017/0259545 A1
(43) Pub. Date: Sep. 14, 2017

(54) THIN FILM DEVICE WITH SEPARABLE CARRIER AND MANUFACTURING METHOD THEREOF

(71) Applicant: DingZing Advanced Materials Inc., Kaohsiung City (TW)

(72) Inventor: Keng-Hsien LIN, Kaohsiung City (TW)

(21) Appl. No.: 15/067,792

(22) Filed: Mar. 11, 2016

(51) Int. Cl. B32B 27/40; B32B 37/06; B32B 7/02

(52) U.S. Cl. CPC B32B 27/40; B32B 7/02; B32B 37/06; B32B 2323/10; B32B 2307/536

(57) ABSTRACT

A manufacturing method for a thin film device with separable carrier consisting of the following steps: First, preparing a mold release layer made from a polypropylene material. Next, preparing a carrier layer made from a polyethylene material, and then separably laminating the mold release layer onto a surface of the carrier layer to obtain a top-bottom laminated separable carrier. Next, coating a low-hardness material onto the other surface of the carrier layer to obtain a thin film substrate with a lamination of the separable carrier. Finally, separating the mold release layer on the thin film substrate from the carrier layer to obtain the thin film device.

### BACKGROUND OF THE INVENTION

(a) Field of the Invention

The present invention relates to a thin film device, and more particularly to a thin film device with separable carrier and manufacturing method thereof.

(b) Description of the Prior Art

With the advancement of technology, plastic products have become closely bound up with people's lifestyles. Examples include sports products, clothing, electronic products, various packaging for food products, or containers used for preserving products. With its characteristic changeable low-hardness and shape, the applications of plastic products are considerably widespread and have become indispensable articles in people's lives.

Wherein, thermoplastic polyurethanes (TPU), with advantages including extensibility, wear resistance, grease-proof, transparency, and flexibility, are seen as a replacement low-hardness material for PVC (polyvinyl chloride). To satisfy environmental requirements of different fields, the shape and structure of elastomer materials will vary depending on the specific final purpose of the product, and will include thread, cord, band, film, fabric, and a plurality of other forms.

However, when elastomer materials are used to manufacture thin films, because the polymer material used to produce the films has properties of stickiness or tackiness, thus, when the elastomer film is being extruded and wound to become a spool, the thin films easily adhere to each other or caking occurs, with problems arising therefrom leading to difficulties or inability to unroll the spool. Furthermore, when the thin films age or are stored in a tepid environment, the caking and sticking becomes even more evident, resulting in the product becoming a reject. Hence, there is an urgent need for improvement.

Referring to FIG. 1, which shows a “Transfer Printing Thin Film” disclosed in the Taiwan Patent No. 1308115. The patent provides a structural design for a transfer printing thin film, which is structured from a transparent (or opaque) substrate layer 11, a mold release layer 12, a thermosol film or a sensor film 13, and a graphic layer 14. An appropriate amount of antistick agent is added to the sensor film 13, and the graphic layer 14 uses a lithographic plate, a relief plate, or a gravure plate for printing, or uses a printer to directly output graphics that rapidly form on the sensor film 13. Because of the addition of an antistick agent, thus, the transfer printing thin film may be freely rolled up into a tubular form or sheet form while preventing the graphics from sticking together and becoming damaged when the scrolls are rolled up or stacked on top of each other.

However, from the above description it can be seen that the transfer printing thin film of the prior art still has the following shortcomings in actual use:

### 1. Damages the Flexibility of the Thin Film

The composition of the 5%˜50% of an antistick agent added to the sensor film 13 comprises compounds including talcum powder, TiO₂ (titanium dioxide), SiO₂ (silicon dioxide), organic or inorganic compounds, and high molecular compounds to prevent the complications of the transfer printing thin film sticking and becoming damaged when the scrolls are rolled up or stacked on top of each other. Wherein, adding an excessive amount of the anticaking agents talcum powder or SiO₂ will damage the flexibility of the thin film and deprive the transfer printed articles the ability to roll-up and unroll.

### 2. Increases Shipment and Delivery Cost

Regarding the transfer printing thin film of the prior art structured from the substrate layer 11, the mold release layer 12, the film 13. and the graphic layer 14, during the production process, the transfer printing thin film is rolled up to form a tubular form to facilitate subsequent storage and transportation. However, because the transfer printing thin film is structured from four layers, apprehension arises about the increased volume of the entire scroll, along with related complications in transportation. Accordingly, the transfer printing thin film of the prior art is unable to achieve reducing cost overheads.

### 3. Unable to Increase Manufacturing Process Efficiency

Because the mold release layer 12 is positioned between the substrate layer 11 and the film 13, its function comes into effect when the graphic layer 14 is formed on the film 13, whereby the mold release layer 12 is used to enable the substrate layer 11 to be torn off. However, equipment for the mold release layer 12 costs millions of dollars, moreover, the manufacturing process is mired in complicated details, and requires a great deal of manual operation. Therefore, the process not only uses up manufacturing working hours, but also increases cost overheads, and is thus unable to effectively increase manufacturing process efficiency.

The aforementioned shortcomings are all evident in the transfer printing thin film of the prior art arising from the various problems encountered in use. Hence, designing a device able to effectively improve the shortcomings in the existing thin film manufacturing process, and develop a method able to accomplish simplifying the manufacturing process time and increase production efficiency would certainly able to achieve the object of effectively reducing costs and increasing market competitiveness.

### SUMMARY OF THE INVENTION

Accordingly, one of the objects of the present invention lies in providing a manufacturing method for a thin film device with separable carrier that comprises a first preparation step, a second preparation step, a laminating step, a coating step, and a separating step.

First, the first preparation step is carried out to prepare a mold release layer using a polypropylene material. Next, the second preparation step is carried out to prepare a carrier layer using a polyethylene material. And then the laminating step is carried out to separably laminate the mold release layer onto one surface of the carrier layer to obtain a top-bottom laminated separable carrier. Next, the coating step is carried out, wherein a low-hardness material is coated onto the other surface of the carrier layer to obtain a thin film substrate with a lamination of the separable carrier. Finally, the separating step is carried out, wherein the mold release layer on the thin film substrate is separated from the carrier layer to obtain the thin film device.

The beneficial effect of the present invention lies in preventing the thin film layers disposed on the second surface of the carrier layer from sticking together by using the carrier layer made from polyethylene provided with the advantages of rapid crystallization and shaping, thereby effectively improving the difficulty in unrolling the thin film layer after being wound into a spool, and avoiding the complications of cracking on the surface of the thin film layer after unrolling, which would result in the product becoming a reject, thus effectively increasing the yield of merchantable products. The material characteristics of the carrier layer and the mold release layer are provided with the advantages including low polarity and poor adhesivity, thereby enabling easy separation of the mold release layer. Furthermore, using the reusable mold release layer eliminates the need to carry out the first drying and heating step and the first preparation step, which, in one aspect, effectively shortens the line of production and increases efficiency, and in another aspect, reduces the use of polypropylene, thereby achieving the environmental requirements for recycling to minimize environment pollution.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic cross-sectional view depicting a transfer printing thin film disclosed in the Taiwan Patent No. 1308115 of the prior art.

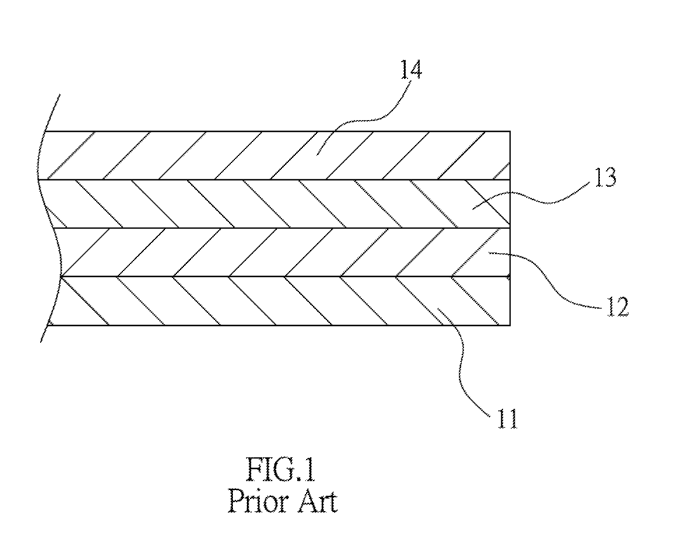

FIG. 2 is a schematic cross-sectional view depicting a preferred embodiment of a thin film device with separable carrier of the present invention.

FIG. 3 is a schematic flow chart of a manufacturing method for a thin film device with separable carrier of the present invention.

FIG. 4 is a schematic cross-sectional view depicting separation of a mold release layer from a carrier layer in a preferred embodiment of the present invention.

### DETAILED DESCRIPTION OF THE PREFERRED EMBODIMENTS

As for the characteristics related to this patent application and technology contents regarding the present invention, a detailed description of the preferred embodiments along with the accompanying drawings is clearly presented below.

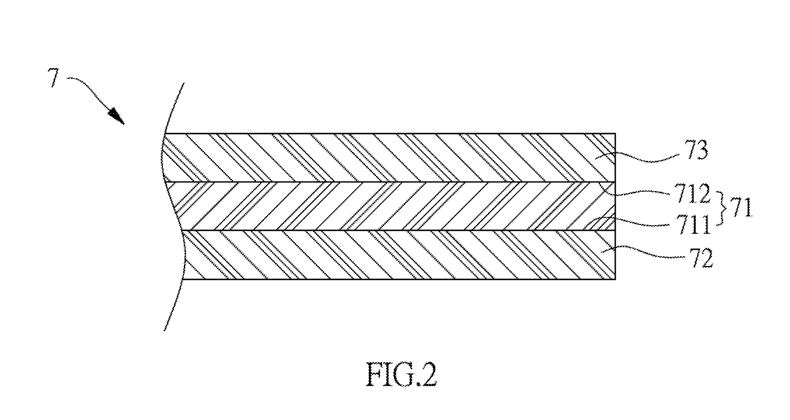

Referring to FIG. 2, which shows a preferred embodiment of a thin film device and with separable carrier and manufacturing method thereof of the present invention, wherein a thin film device 7 with separable carrier comprises a carrier layer 71, a mold release layer 72, and a thin film layer 73.

The carrier layer 71 is made from a polyethylene material, and comprises a first surface 711, and an opposite second surface 712. The thickness of the carrier layer 71 lies between 0.01 mm˜0.1 mm.

The mold release layer 72 is separably disposed on top of the first surface 711 of the carrier layer 71. The mold release layer 72 is made from a polypropylene material and has a thickness that lies between 0.05 mm˜0.3 mm.

Because the mold release layer 72 is made from a polypropylene material, and the hardness of polypropylene is greater than that of the polyethylene material of the carrier layer 71, and the mold release layer 72 is further reinforced by having a thickness range that is about 3˜5 times greater than the thickness range of the carrier layer 71, thus, the carrier layer 71 can be supported by the mold release layer 72 positioned below thereof. In addition, the mold release layer 72 will not easily crease, thus facilitating use for recycling.

The thin film layer 73 is disposed on the second surface 712 of the carrier layer 71. The thin film layer 73 is made from a low-hardness material, which has a hardness range that lies between Shore hardness 65 Shore D to 55 Shore A.

In the preferred embodiment of the present invention, the low-hardness material is a thermoplastic polyurethane material with a thickness that lies between 0.03 mm˜0.005 mm. In actual use, different types of plastic materials can be chosen according to use requirements, and is not limited to any one type.

Because polyethylene and polypropylene are provided with advantages including rapid crystallization and shaping, it is hereby specially described that by using the carrier layer 71 made of polyethylene, the carrier layer 71 is prevented from sticking to the thin film layer 73 disposed on the second surface 712 of the carrier layer 71, thereby effectively improving difficulty in unrolling the thin film layer 73 after winding into a spool or complications resulting from cracking in the surface of the thin film layer 73 and the product becoming a reject after unrolling, thus effectively increasing the yield of merchantable products. The material characteristics of the carrier layer 71 and the mold release layer 72 are provided with the advantages including low polarity and poor adhesivity, which are able to quicken easy separation of the mold release layer 72.

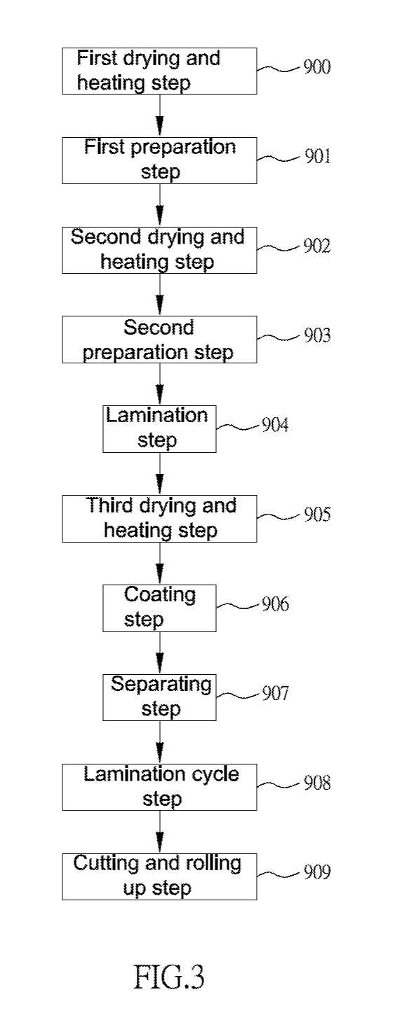

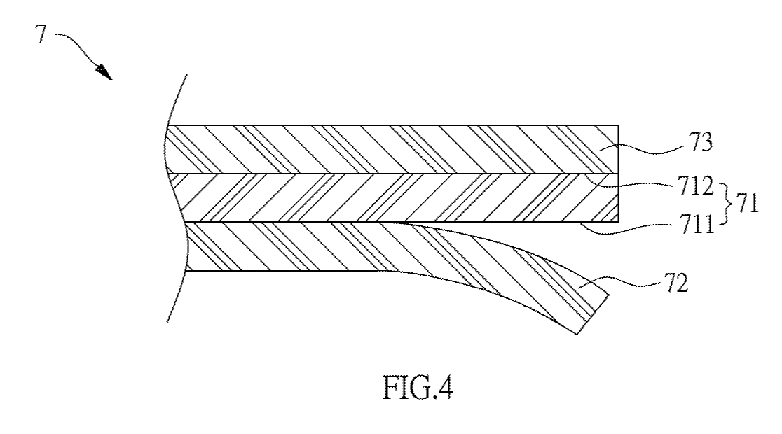

Referring to FIGS. 3 and 4, according to the aforementioned thin film device 7 with separable carrier, the manufacturing method for a thin film device with separable carrier of the present invention comprises a first drying and heating step 900, a first preparation step 901, a second drying and heating step 902, a second preparation step 903, a lamination step 904, a third drying and heating step 905, a coating step 906, a separating step 907, a lamination cycle step 908, and a cutting and rolling up step 909.

First, the first drying and heating step 900 is carried out whereby, after first drying the polypropylene, heating is applied to melt the polypropylene. Next, the first preparation step 901 is carried out to prepare the mold release layer 72 using a polypropylene material. In the first preparation step 901, the polypropylene is first extruded and flattened prior to output to obtain the uniformly thin mold release layer 72. In the preferred embodiment of the present invention, the thickness of the mold release layer 72 is 0.15 mm.

Then, the second drying and heating step 902 is carried out whereby the polyethylene is dried prior to heating to melt the polyethylene. Next, the second preparation step 903 is carried out to prepare the carrier layer 71 using a polyethylene material. In the second preparation step 903, the polyethylene is first extruded and flattened prior to output to obtain the uniformly thin carrier layer 71. In the preferred embodiment of the present invention, the thickness of the carrier layer 71 is 0.07 mm.

When carrying out the first and second drying and heating steps 900, 902, a drying machine may be used to first separately dry the plastic material compounds of polyethylene and polypropylene to evaporate superfluous water, thereby preventing complications of air bubbles forming on the respective surfaces of the plastic material compounds during follow-up processing, and reducing product rejects.

In addition, when carrying out the first and second preparation steps 901, 903, an extruder is used to separately outwardly extrude the polyethylene and the polypropylene. During the extrusion process, a filter screen may be disposed at the outlet area of the extruder to increase the quality of the plastic material compounds. After which, a flatting machine is used to separately flatten the polyethylene and the polypropylene prior to output to respectively obtain the uniformly thin carrier layer 71 and the mold release layer 72, thereby improving the degree of adhesion of the carrier layer 71 and the mold release layer 72 when carrying out the subsequent lamination step 904.

Next, the lamination step 904 is carried out whereby the mold release layer 72 is separably laminated onto the first surface 711 of the carrier layer 71 to obtain a top-bottom laminated separable carrier.

Then, the third drying and heating step 905 is carried out whereby, after drying the low-hardness material, heating is applied to melt the low-hardness material. After which the coating step 906 is carried out whereby the low-hardness material is coated onto the second surface 712 of the carrier layer 71 to form the thin film layer 73 on the carrier layer 71, thereby obtaining a thin film substrate with a lamination of the separable carrier.

In the preferred embodiment of the present invention, the low-hardness material is preferably made from a thermoplastic polyurethane material, and the preferred thickness of the thin film layer 73 is 0.015 mm. In addition, the coating step 906 is used to coat the low-hardness material coat onto the carrier layer 71. And in actual use, different implementation methods may be used to achieve coating, such as laminating, but is not limited by such.

Next, the separating step 907 is carried out whereby the mold release layer 72 on the thin film substrate is separated from the carrier layer 71 to obtain the thin film device 7.

With the design of the ultra thin carrier layer 71 having a thickness of only 0.07 mm and the thin film layer 73 disposed on the second surface 712 of the carrier layer 71, the thin film layer 73 can be supported by the carrier layer 71 after the mold release layer 72 is separated from the carrier layer 71, and will not cause creasing on the surface of the thin film layer 73 because of the mold release layer 72 being torn off, thereby achieving an increase in the yield of merchantable products.

In addition, by only carrying out the first drying and heating step 900 and the first preparation step 901, the mold release layer 72 made from polypropylene is able to replace release paper widely used in the market, thereby, not only eliminating the need to use expensive manufacturing equipment, but also, because of the simple manufacturing process, reducing the use of man power, thereby effectively reducing the manufacturing process time and manufacturing costs. Accordingly, the present invention achieves the effectiveness of increasing the manufacturing process efficiency.

And then, the lamination cycle step 908 is carried out whereby after separating the mold release layer 72 from the thin film substrate, lamination of the carrier layer 71 is repeated in the second preparation step 903, and then implementation of the aforementioned lamination step 904, the coating step 906, and the separating step 907 are repeated to obtain another of the thin film device 7.

Use of the reusable mold release layer 72 enables eliminating carrying out the first drying and heating step 900 and the first preparation step 901, while enabling lamination of the mold release layer 72 to the carrier layer 71. In one aspect, the line of production is effectively shortened and production efficiency is increased, and in another aspect, the use of polypropylene is reduced to achieve the environmental requirements for recycling to minimize environment pollution.

It is hereby specially described that when the user does not require reusing the mold release layer 72, then the lamination cycle step 908 may be eliminated to continue with the follow-up manufacturing process. Such being dependent on use requirements, but is not limited by such.

Finally, the cutting and rolling up step 909 is carried out whereby an appropriate length of the thin film device 7 separated from the mold release layer 72 is chosen for a cutting and rolling up process. In actual use, a cutting machine is installed to cut predetermined lengths of the thin film device 7, and a rolling up machine is further installed to roll up the cut thin film device 7 to carry out subsequent shipment and storage procedures.

It is preferable that the thin film device 7 structured from the carrier layer 71 and the thin film layer 73 not only does not increase the volume of the entire rolled up thin film device 7, but also increases the convenience of transportation and decreases storage volume, all of which enable achieving a reduction in overhead costs.

Furthermore, apart from using the characteristic of the mold release layer 72 made from polypropylene that allows it to not adhere easily, which avoids sticking complications after cutting and rolling up the thin film device 7, moreover, the carrier layer 71 may also serve as a protective coating for the thin film layer 73 to improve the up-to-standard rate of the rolled up thin film device 7 when unfolding and using at the client end, thus further increasing market competitiveness.

From the aforementioned description, it can be understood that the thin film device with separable carrier and manufacturing method thereof of the present invention is surely provided with the following advantages:

### 1. Increases Yield of Merchantable Products

By using the ultra thin carrier layer 71 and disposing the thin film layer 73 on the second surface 712 of the carrier layer 71, after the mold release layer 72 is separated from the carrier layer 71, the thin film layer 73 is then supported by the carrier layer 71; moreover, creasing on the surface of the thin film layer 73 is prevented from occurring because of the mold release layer 72 being torn off, thereby achieving an increase in the yield of merchantable products.

### 2. Reduces Shipment and Delivery Cost

Using the thin film device 7 structured from the carrier layer 71 and the thin film layer 73 not only does not increase the volume of the entire rolled up thin film device 7, but also increases the convenience of transportation and decreases storage volume, all of which enable achieving a reduction in overhead costs. Furthermore, the carrier layer 71 may also serve as a protective coating for the thin film layer 73 to improve the up-to-standard rate of the rolled up thin film device 7 when unfolding and using at the client end, thus further increasing market competitiveness.

### 3. Increases Manufacturing Process Efficiency

The simple manufacturing process of the mold release layer 72 is able to replace release paper used in the market, not only eliminating the need to use expensive manufacturing equipment, but also, because of the simple manufacturing process, reducing the use of man power, thereby effectively reducing the manufacturing process time and manufacturing costs, and further achieving the effectiveness of increasing the manufacturing process efficiency.

### 4. Reusable

Using the reusable mold release layer 72 eliminates the need to carry out the first drying and heating step 900 and the first preparation step 901 while enabling lamination of the mold release layer 72 to the carrier layer 71, which, in one aspect, effectively shortens the line of production and increases efficiency, and, in another aspect, reduces the use of polypropylene, thereby achieving the environmental requirements for recycling to minimize environment pollution.

In conclusion, the thin film device with separable carrier and manufacturing method thereof of the present invention uses reciprocal procedural processing between the first drying and heating step 900, the first preparation step 901, the second drying and heating step 902, the second preparation step 903, the lamination step 904, the third drying and heating step 905, the coating step 906, the separating step 907, the lamination cycle step 908, and the cutting and rolling up step 909, and uses the design of the ultra thin carrier layer 71 whereby, after the mold release layer 72 is separated from the carrier layer 71, the thin film layer 73 is then supported by the carrier layer 71, which will not cause creasing on the surface of the thin film layer 73 because of the mold release layer 72 being torn off, thereby achieving an increase in the yield of merchantable products. Furthermore, the mold release layer 72 is able to replace release paper used in the market, not only because of the simple manufacturing process enables reducing use of manpower and effectively decreases the manufacturing process time and manufacturing costs, but also further increases the manufacturing process efficiency. Accordingly, is indeed able to achieve the object of the present invention.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A manufacturing method for thin film device with separable carrier, comprising steps of:
a) a first preparation step, preparing a mold release layer made from a polypropylene material;
b) a second preparation step, preparing a carrier layer made from polyethylene material;
c) a lamination step, separably laminating the mold release layer onto a surface of the carrier layer to obtain a top-bottom laminated separable carrier;
d) a coating step, coating a low-hardness material onto the other surface of the carrier layer to obtain a thin film substrate with a lamination of the separable carrier; and
e) a separating step, separating the mold release layer on the thin film substrate from the carrier layer to obtain the thin film device.

2. The manufacturing method for thin film device with separable carrier according to claim 1, further comprising a lamination cycle step implemented after carrying out the separating step; in the lamination cycle step, after separating the mold release layer from the thin film substrate, lamination of the carrier layer in the second preparation step is repeated, and then the lamination step, the coating step, and the separating step are repeated to obtain another of the thin film device.

3. The manufacturing method for thin film device with separable carrier according to claim 1, further comprising a cutting and rolling up step implemented after carrying out the separating step; in the cutting and rolling up step, an appropriate length of the thin film device separated from the mold release layer is chosen for cutting and rolling up.

4. The manufacturing method for thin film device with separable carrier according to claim 1, wherein, in the first preparation step, the polypropylene is extruded and flattened prior to output to obtain the uniformly thin mold release layer.

5. The manufacturing method for thin film device with separable carrier according to claim 1, wherein, in the second preparation step, the polyethylene is extruded and flattened prior to output to obtain the uniformly thin carrier layer.

6. The manufacturing method for thin film device with separable carrier according to claim 1, further comprising a first drying and heating step implemented before the first preparation step, and a second drying and heating step that lies between the first preparation step and the second preparation step; in the first drying and heating step, the polypropylene is dried and then heated to melt the polypropylene; and in the second drying and heating step, the polyethylene is dried and then heated to melt the polyethylene.

7. The manufacturing method for thin film device with separable carrier according to claim 1, further comprising a third drying and heating step positioned between the laminating step and the coating step; in the third drying and heating step, the low-hardness material is dried and then heated to melt the low-hardness material, wherein, the low-hardness material is made from a thermoplastic polyurethane material.

8. A thin film device with separable carrier, comprising:
a carrier layer made from a polyethylene material, having a first surface and an opposite second surface, wherein, the thickness of the carrier layer lies between 0.01 mm˜0.1 mm; and
a mold release layer separably laminated onto a first surface of the carrier layer, and made from a polypropylene material, wherein, the thickness of the mold release layer lies between 0.05 mm˜0.3 mm.

9. The thin film device with separable carrier according to claim 8, further comprising a thin film layer disposed on the second surface of the carrier layer; the thin film layer is made from a low-hardness material, and has a hardness range that lies between Shore hardness 65 Shore D to 55 Shore A.

10. The thin film device with separable carrier according to claim 9, wherein the low-hardness material is a thermoplastic polyurethane material, and has a thickness that lies between 0.03 mm˜0.005 mm.
